(19) United States
(12) Patent Application Publication
(10) Pub. No.: US 2017/0316619 A1
(43) Pub. Date: Nov. 2, 2017

(54) THREE-DIMENSIONAL DATA PROCESSING SYSTEM, METHOD, AND PROGRAM, THREE-DIMENSIONAL MODEL, AND THREE-DIMENSIONAL MODEL SHAPING DEVICE

(71) Applicant: FUJIFILM Corporation, Tokyo (JP)

(72) Inventor: Yoshiro KITAMURA, Tokyo (JP)

(73) Assignee: FUJIFILM Corporation, Tokyo (JP)

(21) Appl. No.: 15/654,981

(22) Filed: Jul. 20, 2017

Related U.S. Application Data
(63) Continuation of application No. PCT/JP2016/001539, filed on Mar. 17, 2016.

(30) Foreign Application Priority Data
Mar. 25, 2015 (JP) 2015-062168

(51) Int. Cl. G06T 19/20; G06T 1/00; B33Y 50/00; G09B 23/30; B33Y 30/00

(52) U.S. Cl. CPC G06T 19/20; G09B 23/30; B33Y 30/00; B33Y 50/00; G06T 1/0007

(57) ABSTRACT

Three-dimensional data in which different three-dimensional patterns are respectively added to a plurality of positions of the three-dimensional data representing a three-dimensional object in a three-dimensional coordinate system is created, and the respective added three-dimensional patterns are stored in association with the positions in the three-dimensional data to which the three-dimensional patterns has been added. The three-dimensional model is shaped using the created three-dimensional data. A pattern is recognized in a captured image obtained by imaging the three-dimensional model that is shaped and of which a desired part is excised or incised, a three-dimensional pattern including the recognized pattern is searched for from the stored three-dimensional patterns, and the position in the three-dimensional data stored in association with the three-dimensional pattern that has been searched for is associated with a position on the captured image in which the pattern has been recognized.

### CROSS REFERENCE TO RELATED APPLICATIONS

The present application is a Continuation of PCT International Application No. PCT/JP2016/001539 filed on Mar. 17, 2016, which claims priority under 35 U.S.C. §119(a) to Japanese Patent Application No. 2015-062168 filed on Mar. 25, 2015. Each of the above applications is hereby expressly incorporated by reference, in its entirety, into the present application.

### BACKGROUND

### Technical Field

The present invention relates to a three-dimensional data processing system, method and program, a three-dimensional model, and a three-dimensional model shaping device for shaping a three-dimensional model on the basis of three-dimensional data and performing various simulations using the shaped three-dimensional model.

### Description of the Related Art

In recent years, a technology for shaping a three-dimensional model using a 3D printer has attracted attention. Even in the medical field, planning an operation using a real-sized organ model shaped using a 3D printer or educating an inexperienced surgeon is performed.

Further, in the medical field, a technology for generating and displaying a 3D-VR (virtual-reality) image of an organ on the basis of three-dimensional data of the organ acquired by various modalities such as computed tomography (CT) or magnetic resonance (MR) has been widely spread. Further, for example, an augmented reality (AR) technology for, for example, displaying an actual image obtained by imaging an organ during surgery using a video scope in an endoscopic surgery, a blood vessel structure inside an organ built from a CT image captured in advance or the like being superimposed on the actual image, is also spreading.

In JP2011-224194A, a technology for causing marker points to be formed at a plurality of positions having a predetermined positional relationship on a surface of the three-dimensional model when the three-dimensional model is shaped from three-dimensional data representing an object using a 3D printer, obtaining a correspondence relationship between a coordinate system of the three-dimensional model and a coordinate system of the three-dimensional data using the positions of the plurality of marker points observed on the surface of the shaped three-dimensional model as a clue, generating a virtual reality image corresponding to a region designated on the three-dimensional model by a user from the three-dimensional data on the basis of the correspondence relationship, and presenting the virtual reality image has been proposed.

### SUMMARY

Incidentally, recently, a 3D printer capable of shaping a three-dimensional model using a soft material has appeared. An organ model that reproduces the feel of the organ is formed, and the organ model is excised or incised using an actual surgical instrument so that simulation before surgery can be performed. Therefore, for example, simulation is more effective if a state in which a three-dimensional model is excised or incised can be recognized automatically and various types of information on the state can be presented. However, JP2011-224194A does not provide a method of recognizing a state in which a part of a three-dimensional model is excised or incised.

An object of the present invention is to provide a three-dimensional data processing system, method, and program, a three-dimensional model, and a three-dimensional model shaping device capable of easily recognizing a state in which a part of a three-dimensional model has been excised or incised in view of the above circumstances.

A three-dimensional data processing system according to the present invention includes a data creation unit that creates three-dimensional data in which different three-dimensional patterns are respectively added to a plurality of positions of three-dimensional data representing a three-dimensional object in a three-dimensional coordinate system; a storage unit that stores the respective added three-dimensional patterns in association with positions in the three-dimensional data to which the three-dimensional patterns are added; a three-dimensional shaping unit that shapes a three-dimensional model using the three-dimensional data to which the three-dimensional patterns are added; an image acquisition unit that images the three-dimensional model that is shaped and of which a desired part is excised or incised to generate an acquired image; a pattern recognition unit that recognizes a pattern in the acquired captured image; and an association unit that searches for the three-dimensional pattern including the recognized pattern from among the three-dimensional patterns stored in the storage unit, and associates a position in the three-dimensional data stored in the storage unit in association with the three-dimensional pattern that is searched for with a position on the captured image in which the pattern is recognized.

In the three-dimensional data processing system of the present invention, the storage unit may store two-dimensional patterns that appear on a plurality of different cross-sections of the respective added three-dimensional patterns, in association with positions in the three-dimensional data to which the three-dimensional patterns are added, and the association unit may search for the two-dimensional pattern most similar to the recognized pattern from among the two-dimensional patterns stored in the storage unit, and associate a position in the three-dimensional data stored in the storage unit in association with the three-dimensional pattern including the two-dimensional pattern that is searched for with a position on the captured image in which the pattern is recognized.

Further, the three-dimensional data processing system of the present invention may further comprise an image generation unit that generates a pseudo three-dimensional image corresponding to the captured image from three-dimensional data before the three-dimensional pattern is added, using a correspondence relationship between the position in the three-dimensional data and the position on the captured image in which the pattern is recognized.

In the three-dimensional data processing system of the present invention, the storage unit may store the two-dimensional patterns respectively appearing on a plurality of cross-sections in different directions of the added three-dimensional patterns, in association with the positions in the three-dimensional data to which the three-dimensional patterns are added and directions of the cross-sections on which the two-dimensional patterns appear, and the association unit may search for the two-dimensional pattern most similar to the recognized pattern from among the two-dimensional patterns stored in the storage unit, and associates a position in the three-dimensional data stored in the storage unit in association with the three-dimensional pattern including the two-dimensional pattern that is searched for and a direction of a cross-section on which the two-dimensional pattern that is searched for appears with a position on the captured image in which the pattern is recognized.

Further, the three-dimensional data processing system of the present invention may further comprise: an image generation unit that generates a pseudo three-dimensional image corresponding to the captured image from the three-dimensional data before the three-dimensional patterns are added, using a correspondence relationship between the position in the three-dimensional data and the direction of a cross-section, and a position on the captured image in which the pattern is recognized.

In the three-dimensional data processing system of the present invention, the image generation unit may generate, as the pseudo three-dimensional image, an image representing an internal exposed surface on which the inside of the three-dimensional object is exposed, in an aspect in which the internal exposed surface is visually distinguishable from other surfaces of the three-dimensional object.

In the three-dimensional data processing system of the present invention, the three-dimensional object may include an internal structure therein, and the image generation unit may generate, as the pseudo three-dimensional image, an image representing a state in which the internal structure is exposed to the internal exposed surface on which the inside of the three-dimensional object is exposed.

A three-dimensional data processing system of the present invention may further comprise: a display unit that displays an image; and a display control unit that displays the captured image on the display unit, the generated pseudo three-dimensional image being superimposed on the captured image.

In the three-dimensional data processing system of the present invention, the three-dimensional pattern may include three-dimensionally arranged binary patterns or may include three-dimensionally arranged patterns in which a plurality of colors are combined.

Further, in the three-dimensional data processing system of the present invention, the three-dimensional pattern may be a three-dimensional pattern in which binary patterns or patterns in which a plurality of colors are combined are arranged in a three-dimensional lattice form, and the pattern recognition unit may obtain a position of a vanishing point by performing Hough transformation in each partial image cut out from the acquired captured image, and recognize the pattern using the obtained vanishing point.

In the three-dimensional data processing system of the present invention, the three-dimensional object may be an organ, and the internal structure may be a blood vessel.

A three-dimensional data processing method of the present invention comprises steps of: creating three-dimensional data in which different three-dimensional patterns are respectively added to a plurality of portions of three-dimensional data representing a three-dimensional object in a three-dimensional coordinate system; storing the respective added three-dimensional patterns in a storage unit in association with positions in the three-dimensional data to which the three-dimensional patterns are added; shaping a three-dimensional model using the three-dimensional data to which the three-dimensional pattern is added; imaging the three-dimensional model that is shaped and of which a desired part is excised or incised to acquire a captured image; recognizing a pattern in the acquired captured image; and searching for the three-dimensional pattern including the recognized pattern from among the three-dimensional patterns stored in the storage unit, and associating a position in the three-dimensional data stored in the storage unit in association with the three-dimensional pattern that is searched for with a position on the captured image in which the pattern is recognized.

A three-dimensional data processing program of the present invention causes a computer to execute: a data creation process of creating three-dimensional data in which different three-dimensional patterns are respectively added to a plurality of positions of three-dimensional data representing a three-dimensional object in a three-dimensional coordinate system; a storage process of storing the respective added three-dimensional patterns in a storage unit in association with positions in the three-dimensional data to which the three-dimensional patterns are added; a three-dimensional shaping process of causing a shaping device to shape a three-dimensional model using the three-dimensional data to which the three-dimensional patterns are added; an image acquisition process of acquiring a captured image obtained by imaging the three-dimensional model that is shaped and of which a desired part is excised or incised; a pattern recognition process of recognizing a pattern in the acquired captured image; and an association process of searching for the three-dimensional pattern including the recognized pattern from among the three-dimensional patterns stored in the storage unit, and associating a position in the three-dimensional data stored in the storage unit in association with the three-dimensional pattern that is searched for with a position on the captured image in which the pattern is recognized.

Further, the three-dimensional data processing program of the present invention usually includes a plurality of program modules, and each process is realized by one or more program modules. A group of program modules is recorded on a recording medium such as a CD-ROM or a DVD or recorded in a state in which the group is downloadable in a storage included in a server computer or a network storage, and provided to a user.

A three-dimensional model of the present invention is a three-dimensional model of a three-dimensional object, wherein different three-dimensional patterns are respectively added to a plurality of positions of the three-dimensional object.

A three-dimensional model shaping device of the present invention comprises: a data creation unit that creates three-dimensional data in which different three-dimensional patterns are respectively added to a plurality of positions of three-dimensional data representing a three-dimensional object in a three-dimensional coordinate system; a storage unit that stores the respective added three-dimensional patterns in association with positions in the three-dimensional data to which the three-dimensional patterns are added; and a three-dimensional shaping unit that shapes a three-dimensional model using the three-dimensional data to which the three-dimensional patterns are added.

According to the three-dimensional data processing system, method, and program of the present invention, since the three-dimensional data in which different three-dimensional patterns are respectively added to the plurality of positions of the three-dimensional data representing the three-dimensional object in the three-dimensional coordinate system is created, the respective added three-dimensional patterns are stored in the storage unit in association with the positions in the three-dimensional data to which the three-dimensional patterns has been added, the three-dimensional model is shaped using the three-dimensional data to which the three-dimensional patterns have been added, the three-dimensional model that is shaped and of which a desired part is excised or incised is imaged to acquire a captured image, the pattern is recognized in the acquired captured image, and the three-dimensional pattern including the recognized pattern is searched for from the three-dimensional patterns stored in the storage unit, and the position in the three-dimensional data stored in the storage unit in association with the three-dimensional pattern that has been searched for is associated with a position on the captured image in which the pattern has been recognized, it is possible to easily recognize a state in which a part of the three-dimensional model is excised or incised, according to the position on the three-dimensional object corresponding to each position on the exposed surface of the three-dimensional model, which is represented by the position in the three-dimensional data associated with each position on the captured image.

According to the three-dimensional model of the present invention and the three-dimensional model shaped by the three-dimensional model shaping device of the present invention, since the model is the three-dimensional model of the three-dimensional object, and different three-dimensional patterns are respectively added to a plurality of positions of the three-dimensional object, it is possible to easily recognize a state in which a part of the three-dimensional model is excised or incised from the captured image obtained by imaging the three-dimensional model. Specifically, the pattern is recognized in the captured image obtained by imaging the three-dimensional model, the three-dimensional pattern including the recognized pattern is searched for from the three-dimensional patterns added to the respective positions of the three-dimensional object, and the position in the three-dimensional data to which the three-dimensional pattern that has been searched for has been added is obtained. Therefore, it is possible to easily recognize a state in which a part of the three-dimensional model is excised or incised.

### BRIEF DESCRIPTION OF THE DRAWINGS

FIG. 1 is a diagram illustrating a schematic configuration of a three-dimensional data processing system according to an embodiment of the present invention.

FIG. 2 is a block diagram illustrating functions of a three-dimensional data processing system.

FIG. 3 is a diagram illustrating acquisition of three-dimensional data representing a three-dimensional object.

FIG. 4 is a diagram illustrating a method of creating three-dimensional data to which a pattern has been added.

FIG. 5 is a diagram illustrating an example of a shaped three-dimensional model.

FIG. 6 is a diagram illustrating an example of a captured image obtained by imaging a three-dimensional model before and after a part thereof is excised.

FIG. 7 is a diagram illustrating a state of a three-dimensional model before and after the excision in FIG. 6.

FIG. 8 is a diagram illustrating a method of recognizing a pattern in a captured image.

FIG. 9 is a diagram illustrating association between a position on a captured image and a position in three-dimensional data.

FIG. 10 is a flowchart illustrating a flow of a process that is performed by a three-dimensional data processing system.

### DETAILED DESCRIPTION

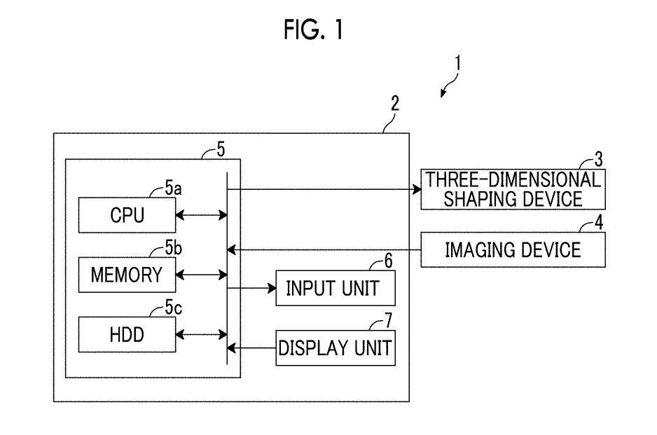

Hereinafter, embodiments of a three-dimensional data processing system, method, and program, a three-dimensional model, and a three-dimensional model shaping device of the present invention will be described. FIG. 1 is a block diagram illustrating a schematic configuration of a three-dimensional data processing system 1. As illustrated in FIG. 1, this system includes a three-dimensional data processing device 2, a three-dimensional shaping device 3, and an imaging device 4.

The three-dimensional data processing device 2 is obtained by installing a three-dimensional data processing program of the present invention in a computer. The three-dimensional data processing device 2 includes a device main body 5 in which a central processing unit (CPU) and the like are included, an input unit 6 that receives an input from a user, and a display unit 7 that performs a display. The input unit 6 is a mouse, a keyboard, a touch pad, or the like. The display unit 7 is a liquid crystal display, a touch panel, a touch screen, or the like.

The device main body 5 includes a CPU 5a, a memory 5b, and a hard disk drive (HDD) 5c. The CPU 5a, the memory 5b, and the HDD 5c are connected to each other by a bus line. In the HDD 5c, the image processing program of the present invention and data referred to by the program are stored. According to the program stored in the HDD 5c, the CPU 5a executes various processes using the memory 5b as a primary storage area.

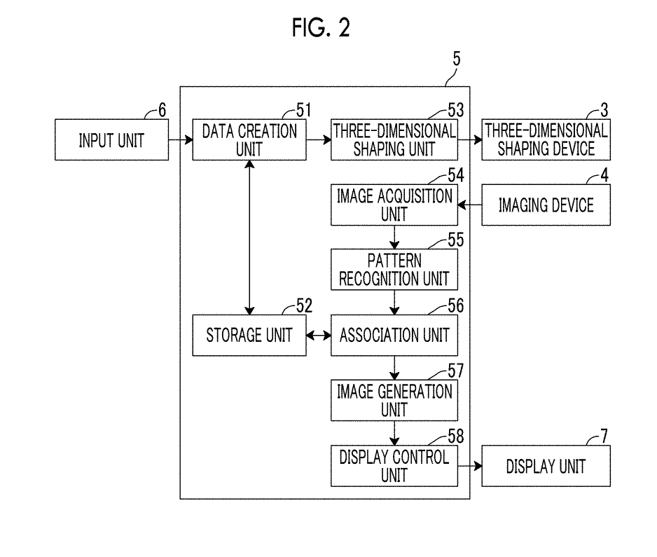

The three-dimensional data processing program defines a data creation process, a storage process, a three-dimensional shaping process, an image acquisition process, a pattern recognition process, an association process, an image generation process, and a display control process as processes caused to be executed by the CPU 5a. According to the definition of the program, the device main body 5 functions as a data creation unit 51, a storage unit 52, a three-dimensional shaping unit 53, an image acquisition unit 54, a pattern recognition unit 55, an association unit 56, an image generation unit 57, and a display control unit 58, as illustrated in FIG. 2, by the CPU 5a executing the respective processes. In this embodiment, the three-dimensional shaping device 3 and the three-dimensional shaping unit 53 correspond to a three-dimensional shaping unit of the present invention, the imaging device 4 and the image acquisition unit 54 correspond to the image acquisition unit of the present invention, and the HDD 5c and the storage unit 52 correspond to the storage unit of the present invention.

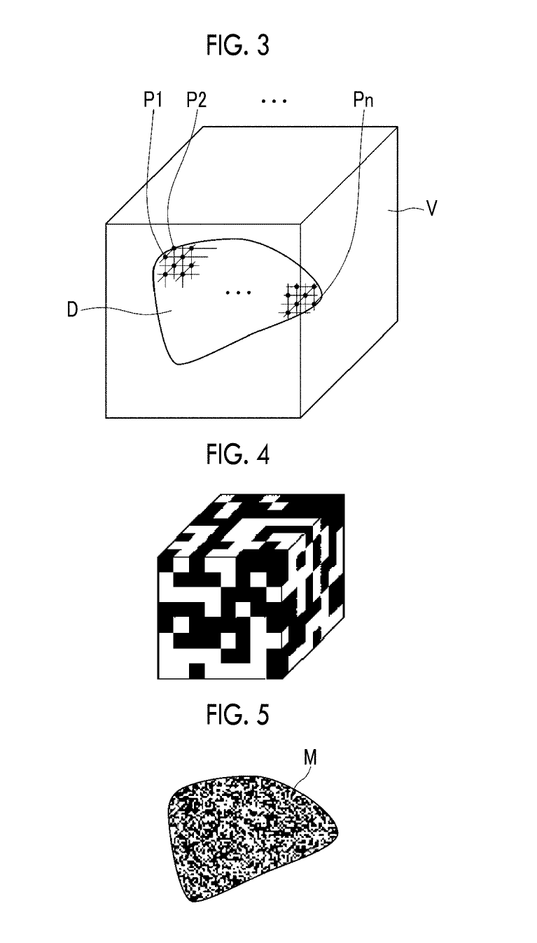

The data creation unit 51 creates three-dimensional data in which different three-dimensional patterns are respectively added to a plurality of positions of three-dimensional data representing a three-dimensional object in a three-dimensional coordinate system. Therefore, the data creation unit 51 first acquires three-dimensional data representing the three-dimensional object. When the three-dimensional object is, for example, a liver, the data creation unit 51 acquires volume data obtained by imaging an abdomen including the liver from a modality such as a computed tomography (CT) device or a magnetic resonance imaging (MRI) device, specifies a range of a region D (hereinafter referred to as a “three-dimensional liver region D”) in which the liver is imaged in a three-dimensional image V represented by the volume data as illustrated in FIG. 3, and acquires a data portion indicating the specified range as three-dimensional data representing the liver. The data creation unit 51 creates three-dimensional data representing the three-dimensional liver region D to which a pattern has been added, by respectively adding different three-dimensional patterns to a plurality of positions Pi (i=1, 2, . . . , n; n is the number of sampling positions) at which the three-dimensional liver region D is three-dimensionally sampled at constant intervals.

As illustrated in FIG. 4, the three-dimensional pattern includes binary block patterns arranged three-dimensionally, and a unique pattern in the entire three-dimensional liver region D is assigned to each surface and each of a plurality of different cross-sections of the three-dimensional pattern. Accordingly, each position Pi on the three-dimensional liver region D can be uniquely identified using a pattern recognized with a certain size or more in an arbitrary surface or cross-section of the three-dimensional pattern. Since the recognition of the pattern is performed using the captured image obtained by imaging the three-dimensional model formed on the basis of the three-dimensional data using the imaging device 4 to be described below, a size of the three-dimensional pattern is set to a size for causing the pattern to be sufficiently recognizable in the captured image obtained by the imaging device 4 imaging the three-dimensional model.

The storage unit 52 stores information on the three-dimensional pattern added to the three-dimensional data in the data creation unit 51 in association with the position Pi (corresponding to a position in the three-dimensional data) in the three-dimensional liver region D at which the three-dimensional pattern has been added, in the HDD 5c. In this case, the storage unit 52 stores information representing a three-dimensional pattern that is a binary pattern in a combination of 0 and 1, as information on a three-dimensional pattern, and stores a coordinate value in a coordinate system of a three-dimensional image V as the position Pi on the three-dimensional liver region D. Since information on the pattern recognized with a certain size or more on each surface of the three-dimensional pattern and a plurality of different cross-sections is present in the information on each three-dimensional pattern, it is possible to specify the three-dimensional pattern including the recognized pattern by collating information on the pattern recognized in the captured image with the stored information on the three-dimensional pattern.

In addition to or in place of the information on the three-dimensional pattern, the storage unit 52 stores the information on the two-dimensional pattern appearing on each surface and each of a plurality of different cross-sections of the three-dimensional pattern in association with the position Pi (corresponding to the position in the three-dimensional data) in the three-dimensional liver region D to which the three-dimensional pattern has been added, in the HDD 5c.

The three-dimensional shaping unit 53 outputs three-dimensional data representing the three-dimensional liver region D to which the three-dimensional pattern has been added, which has been created in the data creation unit 51, to the three-dimensional shaping device 3, and controls the three-dimensional shaping device 3 so that the three-dimensional model M using the three-dimensional data is shaped. The three-dimensional shaping device 3 is a 3D printer that shapes the three-dimensional model M using a laminating shaping method on the basis of the three-dimensional data. Under the control of the three-dimensional shaping unit 53, the three-dimensional shaping device 3 shapes the three-dimensional model M using the three-dimensional data to which the three-dimensional pattern has been added.

The three-dimensional shaping device 3 is a dual-head type 3D printer capable of shaping using a soft gelatinous material with two or more colors, and in this embodiment, when the three-dimensional model M is shaped, the three-dimensional pattern added to the three-dimensional data is shaped using 2-color material. Accordingly, the three-dimensional model M in which the three-dimensional pattern is embedded not only in the surface but also in the inside is shaped.

FIG. 5 illustrates an example of the three-dimensional model M of a liver shaped on the basis of three-dimensional data representing the three-dimensional liver region D to which the three-dimensional pattern has been added. As illustrated in FIG. 5, a pattern corresponding to each position on the surface appears on the surface of the three-dimensional model M. Further, when a part is excised or incised in a surgical simulation performed by a doctor or the like, and the inside is exposed, a pattern corresponding to each position on the internal exposed surface appears on the internal exposed surface on which the inside is exposed.

The imaging device 4 is a camera that optically captures an image of a subject and generates two-dimensional image data as a captured image I. In this embodiment, the imaging device 4 is installed at a position a predetermined distance away from the shaped three-dimensional model M, images the three-dimensional model M to generate a captured image I, and outputs the generated captured image I to the three-dimensional data processing device 2. In this case, the imaging device 4 has a resolution at which a pattern on the three-dimensional model M can be sufficiently recognized by the pattern recognition unit 55 described below in the captured image I obtained by imaging the three-dimensional model M.

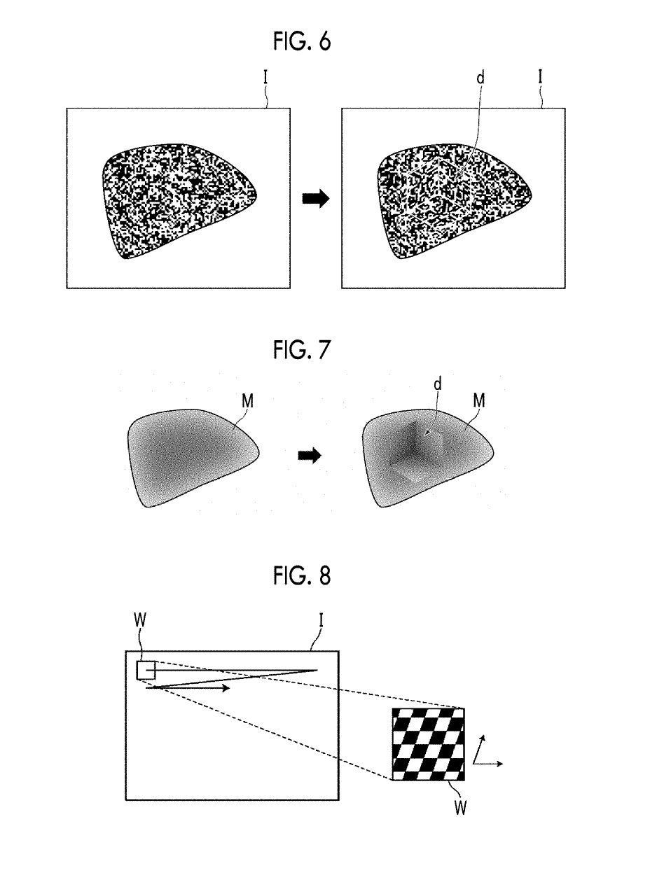

FIG. 6 illustrates an example of the captured image I imaged by the imaging device 4. The left side of FIG. 6 illustrates an example of the captured image I obtained by imaging the three-dimensional model M in a state before the three-dimensional model M is deformed by excision or the like. The right side of FIG. 6 illustrates an example of the captured image I obtained by imaging the three-dimensional model M in a state after a part indicated by an arrow d is excised. FIG. 7 illustrates the three-dimensional model M in a state before and after the excision in FIG. 6. In FIG. 7, a display of a pattern appearing on an exposed surface of the three-dimensional model M is omitted in order for the excised part to be easily confirmed.

The image acquisition unit 54 acquires the captured image I obtained by imaging the three-dimensional model M from the imaging device 4. The captured image I acquired by the image acquisition unit 54 is stored in the HDD 5c.

The pattern recognition unit 55 recognizes a pattern in the captured image I acquired by the image acquisition unit 54. As illustrated in FIG. 7, the pattern recognition unit 55 sequentially cuts out a partial image W having a predetermined size that is a pattern recognition target in a region of the captured image I while shifting a position thereof, performs a process of correcting distortion on the cut partial image W, and recognizes the pattern in the partial image of which the distortion has been corrected. As information on the pattern recognized at each position Qj (i=1, 2, . . . , m; m is the number of positions at which the partial image is cut out) from which the partial image W on the captured image I is cut out, information obtained by representing the pattern in a combination of 0 and 1 is output to the association unit 56.

In this case, the pattern recognition unit 55 first extracts an edge from the partial image W as a process of correcting the distortion. Then, the pattern recognition unit 55 extracts straight lines from the edge image using Hough transformation, and obtains a vanishing point from an intersection point between the straight lines. The distortion of the partial image W is corrected by making the straight line directed to the obtained vanishing point parallel. The process of correcting the distortion is not limited to the above method using Hough transformation. In the process of correcting the distortion, an arbitrary method capable of estimating a normal direction of a surface of the three-dimensional object with respect to a camera can be used. The distortion can be corrected so that the pattern becomes a square lattice pattern on the basis of the estimated normal direction of the surface of the three-dimensional object.

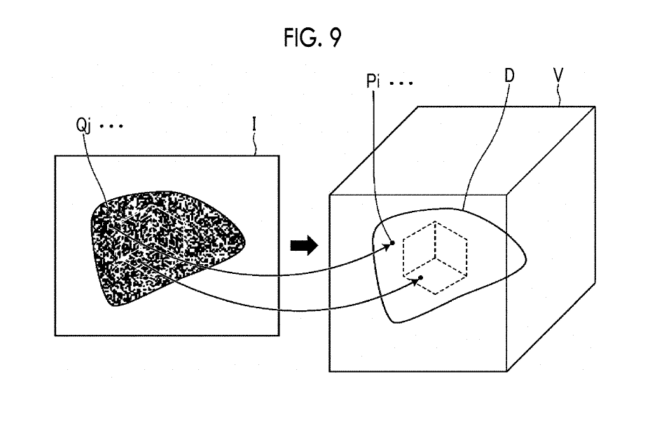

As illustrated in FIG. 9, the association unit 56 obtains the position Pi on the three-dimensional liver region D (corresponding to the position in the three-dimensional data) corresponding to each position Qj in the captured image I. The association unit 56 collates the information on the recognized pattern with the information on the three-dimensional patterns stored in the HDD 5c with respect to each position Qj on the captured image I in which the pattern has been recognized by the pattern recognition unit 55, to specify a three-dimensional pattern including the recognized pattern. The association unit 56 acquires the position Pi on the three-dimensional liver region D stored in the HDD 5c in association with the specified three-dimensional pattern, as a position corresponding to the position Qj on the captured image I. The correspondence relationship between the position Pi on the three-dimensional liver region D and the position Qj in the captured image I acquired by the association unit 56 is stored in the HDD 5c.

In this case, in a case where the two-dimensional pattern appearing on each surface and each of a plurality of different cross-sections of the three-dimensional pattern is stored in the HDD 5c in association with the position Pi on the three-dimensional liver region D to which the three-dimensional pattern has been added, the association unit 56 can collate the information on the pattern recognized at each position on the captured image I with information on the two-dimensional pattern stored in the HDD 5c to specify the two-dimensional pattern including the recognized pattern, and acquire the position Pi on the three-dimensional liver region D stored in the HDD 5c in association with the specified two-dimensional pattern, as a position corresponding to the position on the captured image I, instead of the above method.

Accordingly, at a position on the captured image I obtained by imaging a part not deformed due to excision or the like of the three-dimensional model M, a position on the surface of the three-dimensional liver region D is obtained as a corresponding position, and at a position on the captured image I obtained by imaging a part deformed due to excision or the like of the three-dimensional model M, a position in the inside of the three-dimensional liver region D is obtained as a corresponding position.

The image generation unit 57 generates a pseudo three-dimensional image corresponding to the captured image I from the three-dimensional data representing the three-dimensional liver region D before the three-dimensional pattern is added using a correspondence relationship between a position Pi on the three-dimensional liver region D associated by the association unit 56 and a position Qj on the captured image I in which the pattern is recognized. Specifically, the image generation unit 57 specifies a surface in the three-dimensional liver region D corresponding to an exposed surface of the three-dimensional model M that is captured in the captured image I on the basis of the information on the position Pi of the three-dimensional liver region D corresponding to each position Qj on the image I, and divides the three-dimensional liver region D into a region removed by excision or the like on the specified surface and a remaining region. A projection image obtained by projecting the remaining region on a predetermined projection surface, for example, using a known volume rendering scheme, a known surface rendering method, or the like is generated.

In this case, the image generation unit 57 sets a position of a viewpoint and a direction of a line of sight at which the position Pi of three points on the three-dimensional liver region D corresponding to the position Qj of three arbitrary points on the captured image I having the same positional relationship as a positional relationship among the positions Qj of the three points on the captured image I in the projection image, to generate a projection image using central projection. Accordingly, a pseudo three-dimensional image in which a state in which a part of the three-dimensional model M captured in the captured image I has been excised or incised from a viewpoint position corresponding to an imaging viewpoint of the captured image I is reproduced in a three-dimensional virtual space is generated.

Further, the image generation unit 57 can generate, as a pseudo three-dimensional image, an image representing a surface on the three-dimensional liver region D corresponding to the internal exposed surface on which the inside of the three-dimensional model M is exposed by excision or the like in an aspect in which the surface is visually distinguishable from other surfaces of the three-dimensional liver region D. Further, the image generation unit 57 can also generate, as a pseudo three-dimensional image, an image representing a state in which a blood vessel inside the three-dimensional liver region D is exposed to the surface on the three-dimensional liver region D corresponding to the internal exposed surface of the three-dimensional model M.

The display control unit 58 controls a display of the display unit 7. The display control unit 58 displays the pseudo three-dimensional image generated by the image generation unit 57 alone, side by side with the captured image I, or to be superimposed on the captured image I on the display unit 7.

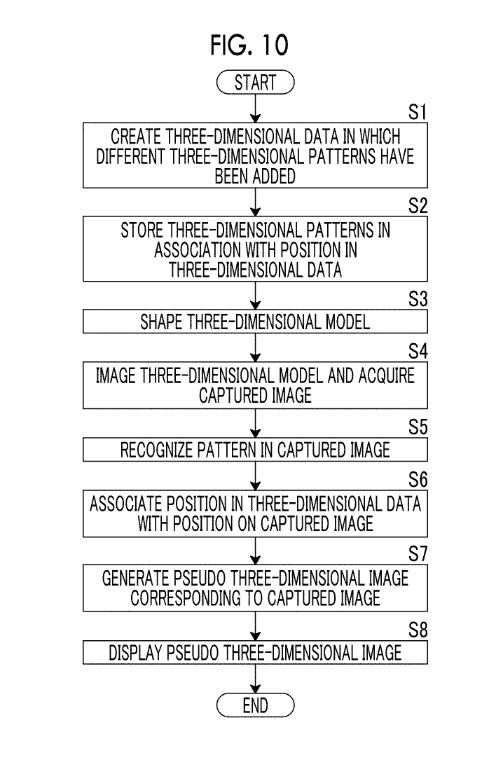

Next, a flow of a process that is performed by the image information storage unit 100 will be described with reference to a flowchart illustrated in FIG. 10. First, the data creation unit 51 acquires the three-dimensional data representing a three-dimensional object in a three-dimensional coordinate system, and creates three-dimensional data in which different three-dimensional patterns have been respectively added to a plurality of positions Pi of the three-dimensional data (S1). Then, the storage unit 52 stores information on the respective three-dimensional patterns added in step S1 in the HDD 5c in association with the position Pi in the three-dimensional data to which the three-dimensional patterns have been added (S2). Then, the three-dimensional shaping unit 53 outputs the three-dimensional data to which the three-dimensional pattern created in step S1 has been added to the shaping device 3, and the three-dimensional shaping device 3 shapes the three-dimensional model M on the basis of the input three-dimensional data (S3).

Then, the imaging device 4 images the three-dimensional model M that has been shaped in step S3 and of which a desired part has been excised or incised to generate a captured image I, and the image acquisition unit 54 acquires the captured image I obtained by capturing the three-dimensional model M from the imaging device 4 (S4). Then, the pattern recognition unit 55 sequentially cuts the partial image W having a predetermined size while shifting a position thereof in the region of the captured image I acquired in step S4, and recognizes a pattern in the cut partial image W (S5). Then, the association unit 56 searches for the three-dimensional pattern including the recognized pattern at each position Qj on the captured image I in step S5 from among the three-dimensional patterns stored in the HDD 5c and associates the position Pi in the three-dimensional data stored in association with the three-dimensional pattern that is searched for with the position Qj on the captured image I of which the pattern has been recognized (S6).

Then, the image generation unit 57 generates a pseudo three-dimensional image corresponding to the captured image I from the three-dimensional data before the three-dimensional patterns are added, using the correspondence relationship between the position Pi on the three-dimensional data and the position Qj on the captured image I associated in step S6 (S7). The display control unit 58 causes the display unit 7 to display the pseudo three-dimensional image generated in step S8 (S8), and ends the process.

With the above configuration, in the three-dimensional data processing system 1 of this embodiment, the data creation unit 51 creates the three-dimensional data in which different three-dimensional patterns are respectively added to the plurality of positions of the three-dimensional data representing the three-dimensional object in the three-dimensional coordinate system, the storage unit 52 stores the respective added three-dimensional patterns in the HDD 5c in association with the positions in the three-dimensional data to which the three-dimensional patterns has been added, the three-dimensional shaping unit 53 outputs the three-dimensional data to which the three-dimensional pattern has been added to the three-dimensional shaping device 3, and the three-dimensional shaping device 3 shapes a three-dimensional model on the basis of the input three-dimensional data. The imaging device 4 images the three-dimensional model M that is shaped and of which a desired part is excised or incised to generate a captured image, and the image acquisition unit 54 acquires the captured image I from the imaging device 4. The pattern recognition unit 55 recognizes a pattern in the acquired captured image, and the association unit 56 searches for the three-dimensional pattern including the recognized pattern from among the three-dimensional patterns stored in the HDD 5c, and associates a position in the three-dimensional data stored in the HDD 5c in association with the three-dimensional pattern that has been searched for with a position on the captured image in which the pattern has been recognized. Accordingly, it is possible to easily recognize a state in which a part of the three-dimensional model is excised or incised, according to the position on the three-dimensional object corresponding to each position on the exposed surface of the three-dimensional model, which is represented by the position in the three-dimensional data associated with each position on the captured image.

Although the case where the three-dimensional data processing device 2 includes the image generation unit 57 or the display control unit 58 has been described in the above embodiment, the configuration is not necessarily required and may be provided, if necessary.

Further, although the case where the three-dimensional pattern is added to a plurality of positions obtained by three-dimensionally sampling the entire range of the three-dimensional liver region D has been described in the above embodiment, the three-dimensional pattern may be added only to a plurality of positions obtained by three-dimensionally sampling a partial region (for example, a region of which excision or incision is scheduled). Further, the sampling interval may be the same in an entire region that is a target or may be different according to a place.

Further, in the above embodiment, the case where the storage unit 52 stores information on the three-dimensional patterns added to the three-dimensional data or information on the two-dimensional patterns appearing on each surface and a plurality of different cross-sections of the three-dimensional pattern in association with positions in the three-dimensional data to which the three-dimensional patterns have been added has been described, but the present invention is not limited thereto, and the storage unit 52 can store the information on the two-dimensional patterns appearing on each surface and a plurality of different cross-sections of the three-dimensional patterns to which the three-dimensional patterns have been added, in association with the positions in the three-dimensional data to which the three-dimensional patterns are added and the directions of the cross-sections on which the two-dimensional patterns appear.

In this case, the association unit 56 can search for the two-dimensional pattern most similar to the recognized pattern from among the two-dimensional patterns stored in the HDD 5c, and associate the position in the three-dimensional data stored in the HDD 5c in association with the three-dimensional pattern including the two-dimensional pattern that has been searched for, and the direction of the cross-section on which the two-dimensional pattern that has been searched for appears, with the position on the captured image in which the pattern has been recognized. Further, the image generation unit 57 can generate a pseudo three-dimensional image corresponding to the captured image from the three-dimensional data to which the three-dimensional patterns are added on the basis of the position on the captured image in which the pattern has been recognized, the position in the three-dimensional data associated with the position, and the direction of the cross-section.

Although the case where the three-dimensional pattern is a binary pattern has been described in the above embodiment, the three-dimensional pattern may include a pattern in which a plurality of colors are combined. When a ternary or more value pattern is used as the three-dimensional pattern, more positions can be identified in a three-dimensional pattern having a small size in comparison with a case in which the binary pattern is used. Although the case in which the three-dimensional pattern is a block pattern has been described in the above embodiment, the three-dimensional pattern may be other kinds of patterns such as a dot pattern or a stripe pattern.

In the above embodiment, the case where the three-dimensional data processing system, method, and program, the three-dimensional model, and the three-dimensional model shaping device of the present invention are applied to the creation of the three-dimensional model of the liver has been described, but is not limited thereto, and the present invention can be applied to a case where a three-dimensional model of other organs or various three-dimensional objects other than the organs are created.

What is claimed is:

1. A three-dimensional data processing system, comprising:
a data creation unit that creates three-dimensional data in which different three-dimensional patterns are respectively added to a plurality of positions of three-dimensional data representing a three-dimensional object in a three-dimensional coordinate system;
a storage unit that stores the respective added three-dimensional patterns in association with positions in the three-dimensional data to which the three-dimensional patterns are added;
a three-dimensional shaping unit that shapes a three-dimensional model using the three-dimensional data to which the three-dimensional patterns are added;
an image acquisition unit that images the three-dimensional model that is shaped and of which a desired part is excised or incised to generate an acquired image;
a pattern recognition unit that recognizes a pattern in the acquired captured image; and
an association unit that searches for the three-dimensional pattern including the recognized pattern from among the three-dimensional patterns stored in the storage unit, and associates a position in the three-dimensional data stored in the storage unit in association with the three-dimensional pattern that is searched for with a position on the captured image in which the pattern is recognized.

2. The three-dimensional data processing system according to claim 1,
wherein the storage unit stores two-dimensional patterns that appear on a plurality of different cross-sections of the respective added three-dimensional patterns, in association with positions in the three-dimensional data to which the three-dimensional patterns are added, and
the association unit searches for the two-dimensional pattern most similar to the recognized pattern from among the two-dimensional patterns stored in the storage unit, and associates a position in the three-dimensional data stored in the storage unit in association with the three-dimensional pattern including the two-dimensional pattern that is searched for with a position on the captured image in which the pattern is recognized.

3. The three-dimensional data processing system according to claim 1, further comprising:
an image generation unit that generates a pseudo three-dimensional image corresponding to the captured image from three-dimensional data before the three-dimensional pattern is added, using a correspondence relationship between the position in the three-dimensional data and the position on the captured image in which the pattern is recognized, which are associated with each other.

4. The three-dimensional data processing system according to claim 1,
wherein the storage unit stores the two-dimensional patterns respectively appearing on a plurality of cross-sections in different directions of the added three-dimensional patterns, in association with the positions in the three-dimensional data to which the three-dimensional patterns are added and directions of the cross-sections on which the two-dimensional patterns appear, and
the association unit searches for the two-dimensional pattern most similar to the recognized pattern from among the two-dimensional patterns stored in the storage unit, and associates a position in the three-dimensional data stored in the storage unit in association with the three-dimensional pattern including the two-dimensional pattern that is searched for and a direction of a cross-section on which the two-dimensional pattern that is searched for appears with a position on the captured image in which the pattern is recognized.

5. The three-dimensional data processing system according to claim 4, further comprising:
an image generation unit that generates a pseudo three-dimensional image corresponding to the captured image from the three-dimensional data before the three-dimensional patterns are added, using a correspondence relationship between the position in the three-dimensional data and the direction of a cross-section that are associated with each other, and a position on the captured image in which the pattern is recognized.

6. The three-dimensional data processing system according to claim 3,
wherein the image generation unit generates, as the pseudo three-dimensional image, an image representing an internal exposed surface on which the inside of the three-dimensional object is exposed, in an aspect in which the internal exposed surface is visually distinguishable from other surfaces of the three-dimensional object.

7. The three-dimensional data processing system according to claim 3,
wherein the three-dimensional object includes an internal structure therein, and
the image generation unit generates, as the pseudo three-dimensional image, an image representing a state in which the internal structure is exposed to the internal exposed surface on which the inside of the three-dimensional object is exposed.

8. The three-dimensional data processing system according to claim 3, further comprising:
a display unit that displays an image; and
a display control unit that displays the captured image on the display unit, the generated pseudo three-dimensional image being superimposed on the captured image.

9. The three-dimensional data processing system according to claim 1,
wherein the three-dimensional pattern includes three-dimensionally arranged binary patterns.

10. The three-dimensional data processing system according to claim 1,
wherein the three-dimensional pattern includes three-dimensionally arranged patterns in which a plurality of colors are combined.

11. The three-dimensional data processing system according to claim 1,
wherein the three-dimensional pattern is a three-dimensional pattern in which binary patterns or patterns in which a plurality of colors are combined are arranged in a three-dimensional lattice form, and
the pattern recognition unit obtains a position of a vanishing point by performing Hough transformation in each partial image cut out from the acquired captured image, and recognizes the pattern using the obtained vanishing point.

12. The three-dimensional data processing system according to claim 7,
wherein the three-dimensional object is an organ, and the internal structure is a blood vessel.

13. A three-dimensional data processing method, comprising steps of:
creating three-dimensional data in which different three-dimensional patterns are respectively added to a plurality of positions of three-dimensional data representing a three-dimensional object in a three-dimensional coordinate system;
storing the respective added three-dimensional patterns in a storage unit in association with positions in the three-dimensional data to which the three-dimensional patterns are added;
shaping a three-dimensional model using the three-dimensional data to which the three-dimensional patterns are added;
imaging the three-dimensional model that is shaped and of which a desired part is excised or incised to acquire a captured image;
recognizing a pattern in the acquired captured image; and
searching for the three-dimensional pattern including the recognized pattern from among the three-dimensional patterns stored in the storage unit, and associating a position in the three-dimensional data stored in the storage unit in association with the three-dimensional pattern that is searched for with a position on the captured image in which the pattern is recognized.

14. A non-transitory computer-readable recording medium having stored therein a three-dimensional data processing program for causing a computer to execute:
a data creation process of creating three-dimensional data in which different three-dimensional patterns are respectively added to a plurality of positions of three-dimensional data representing a three-dimensional object in a three-dimensional coordinate system;
a storage process of storing the respective added three-dimensional patterns in a storage unit in association with positions in the three-dimensional data to which the three-dimensional patterns are added;
a three-dimensional shaping process of causing a shaping device to shape a three-dimensional model using the three-dimensional data to which the three-dimensional patterns are added;
an image acquisition process of acquiring a captured image obtained by imaging the three-dimensional model that is shaped and of which a desired part is excised or incised;
a pattern recognition process of recognizing a pattern in the acquired captured image; and
an association process of searching for the three-dimensional pattern including the recognized pattern from among the three-dimensional patterns stored in the storage unit, and associating a position in the three-dimensional data stored in the storage unit in association with the three-dimensional pattern that is searched for with a position on the captured image in which the pattern is recognized.
